(19) United States
(12) Patent Application Publication
(10) Pub. No.: US 2007/0286158 A1
(43) Pub. Date: Dec. 13, 2007

(54) Telecommunications Network

(76) Inventor: Nicholas Cook, Leamington Spa Warwickshire (GB)

Correspondence Address: COATS & BENNETT, PLLC, 1400 Crescent Green, Suite 300, Cary, NC, 27518, US

(21) Appl. No.: 10/598,501

(22) PCT Filed: Feb. 24, 2005
(86) PCT No.: PCT/EP05/50795

§ 371 Date: May 25, 2007

(30) Foreign Application Priority Data
Mar. 5, 2004 (GB) 0405004.3

(51) Int. Cl. H04L 12/66

(52) U.S. Cl. 370/352

(57) ABSTRACT

A media gateway (40) of a telecommunication network, comprises at least one pulse code modulation connection (42a, 42b, 42c or 42d) coupling the media gateway (40) to a pulse code modulation network, not illustrated, and at least one Ethernet connection (44a or 44b) coupling the media gateway (40) to an Ethernet network, not illustrated. The media gateway (40) further comprises a media streaming unit (52) arranged to determine whether or not incoming signals of either the pulse code modulation network or the Ethernet network relate to media data. Dependent on a positive determination, the media streaming unit (52) is arranged to convert signals that relate to media data from the pulse code modulation network into signals compatible with the Ethernet network and visa versa. Furthermore, dependent on a negative determination, the media streaming unit (52) is arranged to forward signals that relate to non-media data to a gateway core processor (56).

The present invention relates to a telecommunication network, in particularly to a telecommunication network including an improved media gateway.

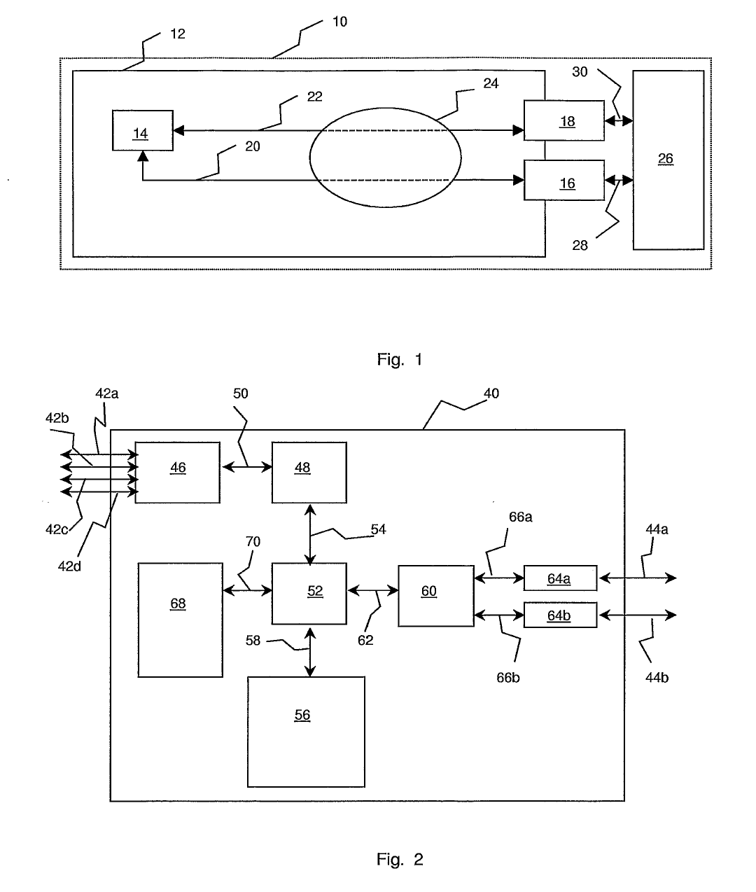

FIG. 1, illustrates a prior art telecommunication network 10 comprising an internet protocol system 12 having a call control agent 14 operably connected to at least one signal gateway 16 and at least one media gateway 18 via internet protocol communication channels 20 and 22, respectively, over an internet protocol network 24. In this instance, the signal gateway 16 and media gateway 18 are arranged to connect the internet protocol system 12 to a pulse 15 code modulation network 26, for example a legacy public switched telephone network, via a pulse code modulation time division multiplexed link 28 between the signal gateway 16 and the pulse code modulation network 26 and a pulse code modulation time division multiplexed link 30 between the media gateway 18 and the pulse code modulation network 26.

In operation, the call control agent 14 receives signalling requests from the signal gateway 16 and, if a call is to be made either to or from the internet protocol system 12 via the media gateway 18, then the call control agent 14 instructs the media gateway 18 via media gateway control protocol over internet protocol communication channel 22 to open a communication path such that the media data can be transferred across the media gateway 18 either from the internet protocol system 12 to the pulse code modulation network 26 via link 30 or, visa versa, from the pulse code modulation network 26 to the internet protocol system 12, again via link 30. During the transfer of the data, the call control agent 14 associated with the internet protocol system 12 is in communication with the pulse code modulation network 26 via the signal gateway 16 using a signalling system, for example Signalling System 7, over internet protocol communication channel 20 such that the call control agent 14 maintains control of the data transferred over the communication path via link 30, media gateway 18 and communication channel 22 of the internet protocol system 12.

However, the inventor has recognised that using the telecommunication network 10 as detailed above results in the media gateway 18 processing both media and non-media type data and that it would be beneficial to deal with media and non-media type data independently. That is, although the term “media gateway” is commonly applied to the prior art device described above, the media gateway 18 in fact handles both media and non-media type data. Examples of non-media data could be call control data or media supervision data. This results in delays in the transmission of media type data through the media gateway 18 and reduces the amount of call control type data that the media gateway 18 can handle. An example of media type data is speech.

It is an object of the present invention to obviate or mitigate the disadvantages associated with the prior art.

According to a first aspect of the present invention a telecommunication network comprising a packetized network, a call control agent associated with the packetized network, the call control agent being arranged to control at least one communication channel across the packetized network, and at least one media gateway associated with the call control agent, the media gateway being arranged to receive and convert signals compatible with a first communication format arriving at the media gateway into signals compatible with a second communication format, wherein the media gateway has associated therewith a media streaming unit that is arranged to determine whether or not the signals of the first communication format relate to media data.

In this manner, the media gateway of the invention separates its primary function, i.e. the transmission of media data, from the handling of non-media data. This results in an increase in the range of media data packetization periods that the media gateway can process. Furthermore, separation of the media and non-media type data by the media gateway results in an increase in speed of operation of the telecommunication network. That is, as will become clear from the description of the invention, the rate of Busy Hour Call Attempts (BHCA) achieved by the media gateway can be increased by decoupling the handling of media data from non-media data in the media gateway.

Furthermore, as the media gateway is primarily focussed on the transportation of media data, jitter effects associated with the transfer of media data over a packetized network are mitigated. Other advantages associated with the invention will also be apparent from the following description of the invention.

Preferably, dependent on a positive determination, the media streaming function may be arranged to convert signals that relate to media data and that are compatible with the first communication format into signals compatible with the second communication format for onward transmission on a communication channel across the packetized network. Also, dependent on a negative determination, the media streaming unit may be arranged to forward signals that relate to non-media data to a gateway core processor associated with the media gateway.

Furthermore, the media streaming unit may be arranged to determine whether or not the signals of the second communication format relate to media data and, dependent on a positive determination, may be arranged to convert signals that relate to media data and that are compatible with the second communication format into signals compatible with the first communication format for onward transmission on a communication channel adapted to transport signals compatible with the first communication format. The media streaming unit may also be arranged to determine whether or not the signals of the second communication format relate to media data and, dependent on a negative determination, may be arranged to forward such signals that relate to non-media data to a gateway core processor associated with the media gateway.

The first communication format may be pulse code modulation and the second communication format may be a packetized scheme, for example Ethernet or an internet protocol scheme.

The media streaming unit may be a field programmable gate array.

The determination of whether or not the signals of the first communication format relate to media data or whether or not the signals of the second communication format relate to media data may be determined from a call records detail associated with the signals.

According to a second aspect of the present invention, a method of operating a media gateway comprises determining whether or not the signals of a first communication format relate to media data and, dependent on a positive determination, converting such signals into signals compatible with a second communication format.

According to a third aspect of the present invention, a media gateway, for connection of a first network to a second network, is arranged to receive and convert signals compatible with a first communication format arriving at the media gateway into signals compatible with a second communication format, wherein the media gateway has associated therewith a media streaming unit that is arranged to determine whether or not the signals of the first communication format relate to media data.

Preferably, the media streaming unit, dependent on a positive determination, may be arranged to convert signals that relate to media data and which are compatible with the first communication format into signals compatible with the second communication format for onward transmission on a communication channel of the second network. Furthermore, the media streaming unit, dependent on a negative determination, may be arranged to forward signals that relate to non-media data to a gateway core processor associated with the media gateway.

The media streaming unit may be arranged to determine whether or not the signals of the second communication format relate to media data and, dependent on a positive determination, to convert signals that relate to media data and which are compatible with the second communication format into signal compatible with the first communication format for onward transmission on a communication channel of the first network. Also, the media streaming unit, dependent on a negative determination, may be arranged to forward signals which relate to non-media data to a gateway core processor associated with the media gateway.

The invention will now be described, by way of example only, with reference to the accompanying drawings, in which:

FIG. 1 illustrates a prior art telecommunication network including a media gateway;

FIG. 2 illustrates a media gateway of a telecommunication network according to the present invention;

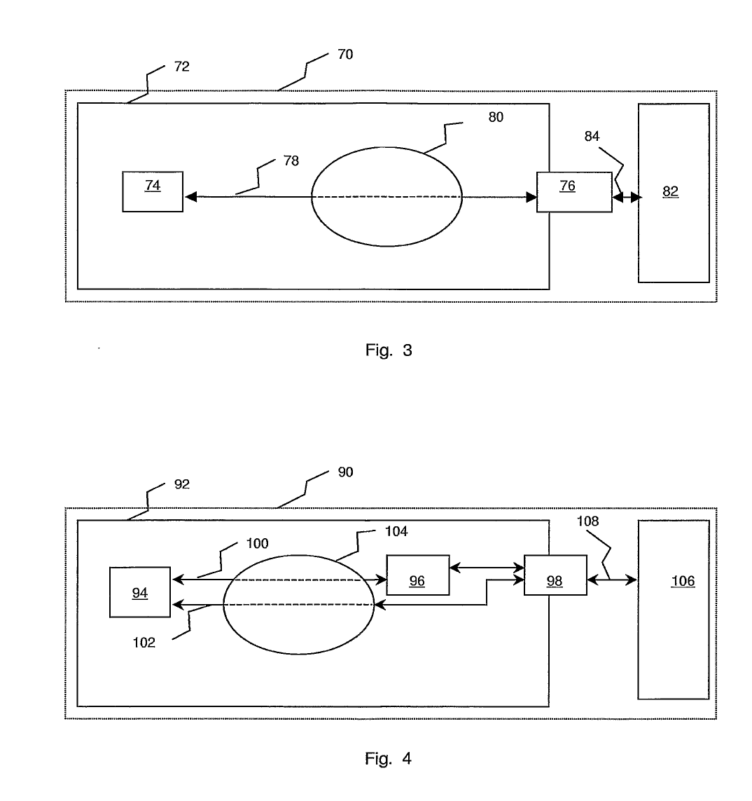

FIG. 3 illustrates an alternative telecommunication network according to the present invention; and

FIG. 4 illustrates a further alternative telecommunication network according to the present invention.

Referring to FIG. 2, a media gateway 40 of a telecommunication network similar in configuration to that described with reference to FIG. 1, comprises one or more bi-directional pulse code modulation connections 42a, 42b, 42c and 42d coupling the media gateway 40 to a pulse code modulation network, not illustrated, using time division multiplexing. Furthermore, the media gateway 40 also comprises one or more, in this example two for resilience purposes, bidirectional Ethernet connections 44a and 44b coupling the media gateway 40 to an Ethernet network, not illustrated.

In operation, for example for data transmission from the pulse code modulation network to the Ethernet network, the pulse code modulation connections 42a, 42b, 42c and 42d from the pulse code modulation network are terminated at a pulse code modulation terminator 46 and received data is then forwarded, via connection 50, to a correct digital signal processor in a bank of digital signal processors 48 based on a timeslot map. The time slot map is provided via a programmable logic device arranged to direct each time slot of each pulse code modulation connection 42a, 42b, 42c and 42d to the correct digital signal processor of the bank of digital signal processors 48. It will be understood that such a programmable logic device is programmed to perform its function during the commissioning of the media gateway 40. Each digital signal processor of the bank of digital signal processors 48 performs signal processing functions on received data and sends the resultant data to a media streaming unit 52 via connection 54. Examples of signal processing functions could include echo cancellation, speech encoding, speech decoding, jitter buffering and tone detection.

The media streaming unit 52 is a field programmable gate array configured to decode the resultant data received from the bank of digital signal processors 48 and to determine the validity of the call. The decoding of the data received by the media streaming unit 52 enables the unit 52 to determine whether or not the resultant data is media or non-media type data. This is achieved by decoding a call details record associated with the resultant data. The call details record associated with data will be described in more detail below.

If it is determined from the call details record that the resultant data is non-media type data then the non-media data is transferred to a software core processor 56 via connection 58 for further processing. That is, the media streaming unit 52 transfers non-media data directly to the software core processor 56 without further processing.

Any internet protocol packets or processing commands generated by the software core processor 56, including any response to the non-media data received from the media streaming unit 52, are transmitted back to the media steaming unit 52 via connection 58. The media streaming unit 52 is arranged to interleave any generated internet protocol packets with any other internet protocol packets transmitted to an Ethernet terminus 60 on connection 62 or to interleave processing commands with media data transmitted by the media streaming unit 52 to the bank of digital signal processors 48 on connection 54. The handling of processing commands, including digital signalling processing commands for the bank of digital signal processors 48, issued by the software core processor 56 is explained in more detail below. In the case of internet protocol packets issued by the software core processor 56, the media streaming unit 52 prepares each internet protocol packet for onward transmission, i.e. adds an Ethernet header to each internet protocol packet, and forwards generated Ethernet packets to the Ethernet terminus 60 over connection 62. The Ethernet terminus 60 is arranged to transfer, via Ethernet line terminators 64a and 64b, Ethernet packets presented to it by the media streaming unit 52 so as to fill the Ethernet network attached to the Ethernet line terminators 64a and 64b. That is, the Ethernet packets are fed from the Ethernet terminus 60 to one of Ethernet connections 44a or 44b on connections 66a and 66b respectively, then via Ethernet line terminators 64a and 64b, for transmission over the Ethernet network. In the case that the media streaming unit 52 determines that the resultant data received from the bank of digital signal processors 48 is media type data, then the media streaming unit 52 converts the media data into standardised packets, i.e. adds internet protocol and Ethernet header information to the media data using the call details record associated with the media data and transfers generated Ethernet packets to the Ethernet terminus 60 over connection 62. Again, the Ethernet terminus 60 is arranged to transfer, via the Ethernet line terminators 64a and 64b, Ethernet packets presented to it by the media streaming unit 52 so as to fill the Ethernet network attached to the Ethernet line terminators 64a and 64b. That is, the Ethernet packets are fed from the Ethernet terminus 60 to one of Ethernet connections 44a or 44b on connections 66a and 66b respectively, then via Ethernet line terminators 64a and 64b, for transmission over the Ethernet network.

It will be understood that the media gateway 40 is a bidirectional device and can also operate to transmit data from the Ethernet network to the pulse code modulation network. That is, data arriving at the Ethernet line terminators 64a and 64b in the form of Ethernet packets over either Ethernet connection 44a or 44b is transferred to the Ethernet terminus 60 over either connection 66a or 66b for consistency checking of the Ethernet packets, for example cyclic redundancy checking (CRC) and determination that the Ethernet packets are the correct length. The Ethernet packets are then transmitted to the media streaming unit 52 over connection 62 for re-transmission to a memory device 68 connected to the media streaming unit 52 via connection 70 without processing by the media streaming unit 52. The memory device 68 is arranged to provide a memory storage area for Ethernet packets and it will be noted that the Ethernet terminus 60 has standing instructions as to where in the memory device 68 to store Ethernet packets emanating from the Ethernet line terminators 64a and 64b such that the media streaming device 52 can readily access the Ethernet packets based on expected memory location within the memory device 68. The media streaming unit 52 accesses and decodes the Ethernet packets stored in the memory device 68 and determines whether or not the data contained in the Ethernet packet is media data or non-media data.

For example, if the media streaming unit 52 determines from the call details record associated with the data in the Ethernet packet is non-media type data, then it is passed directly from the media streaming unit 52 to the software core processor 56 via connection 58 for further processing. That is, the media streaming unit 52 transfers Ethernet packets relating to non-media data directly to the software core processor 56 without further processing.

Otherwise, if the media streaming unit 52 determines from the call details record associated with the data in the Ethernet packet that the data is media type data, then the media streaming unit 52 removes the internet protocol and Ethernet header information from the Ethernet packet and transfers the media data to its correct digital signal processor in the bank of digital signal processors 48 over connection 54 using information from the call details record associated with the media data. The digital signal processor performs signal processing operations on the media data and ultimately the media data is provided to the pulse code modulation terminator 46 via connection 50 for transmission to the pulse code modulation network over a time slot of one of the pulse code modulation connections 42a, 42b, 42c and 42d.

As indicated above, the software core processor 56 can produce processing commands so as to control other elements in the media gateway 40, for example the bank of digital signal processors 48. This is achieved by the software core processor 56 generating digital signal processing commands and passing these to the media streaming unit 52 over connection 58. The media streaming unit 52 in turn is arranged to interleave the digital signal processing commands with media data to be transmitted to the bank of digital signal processors 48 over connection 54. As previously described, the media streaming unit 52 also strips off irrelevant internet protocol and Ethernet header information from Ethernet packets before forwarding media data content to the bank of digital signal processors 48. Furthermore, responses to the digital signal processing commands generated by the bank of digital signal processors 48 are transmitted back to the software core processor 56 via the intermediate media streaming unit 52 over connections 54 and 58. That is, responses to digital signal processing commands are detected by the media streaming unit 52, which directs the processing commands to the software core processor 56 without processing the processing commands as media data. It will be noted that other processing commands may be generated by the software core processor 56 or other elements in the media gateway 40 in response to those generated by the software core processor 56 and that these may be handled in a similar manner by the intermediate media streaming unit 52.

As has been described above, the media streaming unit determines whether or not data is media or non-media type data from the call details record associated with the data. It will be noted that one call details record is generated per timeslot for each pulse code modulation connection 42a, 42b, 42c and 42d. The software core processor 56 can select a user data protocol port, which is included in an internet protocol packet, so that the media streaming unit 52 can perform a decode and select the correct call details record associate with the data. This allows a variation in user data protocol port to be utilized so as to provide protection from previously set up media streams still active although they should have been closed. However, for the determination of the call details record for associated data to be even faster, a call details record can be selected based on a simple mathematical expression of the destination user data protocol port included in a packet, for example:

$$Call Details Record = ( \frac{Destination User Data Protocol Port}{2} ) \& 127$$

That is, the correct call details record for a packet is given by the resultant of dividing the destination user data protocol port from the incoming packet by two and then performing a logical AND function on the result with numerical one hundred and twenty seven.

A call details record may comprise the following information:
1) A full Ethernet header and an internet protocol header defining a particular communication channel;
2) A destination user data protocol port identifier for a call, i.e. a port to which the media gateway 40 has to send data to at a remote device;
3) A source user data protocol port identifier for a call, i.e. a port to which a remote device sends data via the media gateway 40;
4) Whether or not the call is a hairpin call, i.e. should the associated media data be returned directly to the bank of digital signal processors 48 without the media streaming unit 52 forwarding the media data to either the software core processor 56 or the Ethernet terminus 60 as described below;
5) An identifier for a digital signal processor in the bank of digital signal processors 48 to which data is to be sent; and
6) A validity flag.

It will be noted that the call details record may also contain further information.

The hairpin field of the call details record relates to a specific type of call wherein the media streaming unit 52 needs to loop back the media data associated with the call details record to a digital signal processor of the bank of digital signal processors 48 as it is destined for another timeslot on one of the pulse code modulation connections 42a, 42b, 42c or 42d. The digital signal processor to which the media data is to be sent is identified to the media streaming unit 52 by the destination user data protocol port of packet and then looking up the call details record to which it corresponds, i.e. the destination user data protocol port allows the destination call details record to be found, which can then be examined to determine the correct digital signal processor of the bank of digital signal processors 48 to which the data should be sent. In the event of a hairpin type call, the media data is returned to the relevant digital signal processor with negligible jitter and with negligible delay. That is, the media steaming unit 52 sends such media data back to the bank of digital signal processors 48 rather than attempting to pass the data to the Ethernet terminus 60.

If it is not possible for the media streaming unit 52 to produce a full Ethernet header for an Ethernet packet, i.e. due to missing information associated with the Ethernet packet, for example, the next hop media access control address, the media streaming unit 52 is arranged to send an address resolution protocol packet to the device that generated the Ethernet packet. The response from the addressed device is picked up by the software core processor 56 and used to generate a full Ethernet header for the Ethernet packet.

It will be noted that the decoupling of the media and non-media type data is performed by virtue of the fact that the media streaming u nit 52 sees all data before the software core processor 56 sees the data. Therefore, the software core processor 56 is only utilized when data needs to be modified or to handle non-media data, i.e. the software core processor 56 does not see media type data due to of the intervention of the media streaming unit 52.

Furthermore, once media data has been detected by the media streaming unit 52, the media data will not occupy processing time of the software core processor 56. That is, processing of media data is handled entirely by the media streaming unit 52. However, modifications to a stream of media data in a call can be made by the software core processor 56, as required, without disturbing the transfer of media data by the media streaming unit 52.

The invention provides a number of benefits, including:
1) The decoupling of media data from non-media data results in an increase in the BHCA rate;
2) Network jitter effects is a problem associated with transferring media data either to or from an internet protocol network when there is not a constant stream of media data to fill the pulse code modulation connections 42a, 42b, 42c or 42d. Network jitter is defined as the variance in packet delays from source to destination. A known technique to mitigate this effect is to employ a jitter buffer. However, jitter effects can also occur across a prior art media gateway 18 as many processes are competing for processing time within the prior art gateway 18. Again, in prior art implementations, this form of jitter effect has been handled by the jitter buffer. It will of course be understood that the combination of jitter effects across the prior art media gateway 18 and network jitter require the jitter buffer to work harder.
   The handling of media data across the media streaming unit 52 of the present invention is highly parallel, which allows the media streaming unit 52 to consistently stream media data to and from the Ethernet network. This results in a further mitigation of jitter effects and eases the burden placed on jitter buffers, if employed;
3) Another important time to measure on a media gateway 40 is the transit time. This is the time it takes for media data to get from the internet protocol network to the pulse code modulation network and vice versa. A high transit time imparts a delay into the transmission of media data that can affect the quality of a call. An extreme example of this is exhibited in satellite telephone calls wherein the transit time or delay is so large that by the time a destination user hears speech from a source user, the source user may have changed subject. This can result in the call feeling unnatural to the users. The delays in a media gateway 40 are not as extreme as those associated with satellite telephone calls, but it will be understood that the shorter the delay the better media gateway 40. Moreover, the shorter the delay, the closer the telephone conversation resembles a legacy public switched telephone network call. Other delays occur in the internet protocol network, but by reducing the transit time across the media gateway 40 the total delay time is decreased. The transit time in the present invention is mitigated as the media streaming unit 52 processes media data packets in parallel whilst other elements in the media gateway process non media type data. Furthermore, the processing of media data is performed in hardware, which further enables the transit time to be reduced;
4) The amount of media data that is conveyed in a single internet protocol packet is called the packetization period. The shorter the packetization period, the shorter the delay from a speaker to a listener during a call. A shorter packetization period can arguably make the call seem more natural to the speaker and listener. However, when a shorter packetization period is employed, the amount of internet protocol header processing becomes disproportionate to the amount of media data used to convey the call. This imparts a significant change in processing load undertaken by the media gateway 40. The media gateway 40 of the present invention can handle a greater range of packetization periods, without affecting the BHCA, as it utilises a dedicated media streaming unit 52 such that the additional load incurred by using a shorter packetization period does not effect other elements of the media gateway 40; and
5) The media streaming unit 52 detects media data transfers from the pulse code modulation connections 42a, 42b, 42c or 42d that are destined for other pulse code modulation connections 42a, 42b, 42c or 42d or timeslots on the same pulse code modulation connection either 42a, 42b, 42c or 42d. Upon detecting such a hairpin call, the media streaming unit 52 loops the associated media data back to the correct time slot on one of connections 42a, 42b, 42c or 42d without necessitating the processing of such media data in the internet protocol network. This allows the transit time and jitter associated with such calls to be mitigated, which in turn allows the media gateway 40 to provide media data hairpin calls with characteristics approaching those possible using a public switched telephone network.

In an alternative embodiment of the invention as illustrated in FIG. 3, a telecommunication network 70 comprising an internet protocol system 72 having a call control agent 74 operably connected to a media gateway 76, substantially as described above with reference to FIG. 2, via internet protocol communication channel 78, over an internet protocol network 80. In this instance, the media gateway 76 is arranged to connect the internet protocol system 72 to a pulse code modulation network 82, for example a legacy private branch exchange, via a pulse code modulation time division multiplexed link 84 between the media gateway 76 and the pulse code modulation network 82.

In this embodiment, instead of terminating signalling at a separate signalling gateway, the signalling is passed into the media gateway 76 via timeslots on the pulse code modulation link 84. Therefore, when using appropriate signalling with a private branch exchange connection, such as Q.921, the media gateway 76 can analyse the signalling data and back haul the relevant information to the call control agent 74. The call control agent 74 can then set up media streams through the media gateway 76 as required.

Furthermore, signalling destined for the pulse code modulation network 82 can be passed from the media gateway 76 via time slots on the pulse code modulation link 84.

Referring to FIG. 4, a further alternative embodiment of the invention is shown, wherein a telecommunication network 90 comprising an internet protocol system 92 having a call control agent 94 operably connected to at least one signal gateway 96 and at least one media gateway 98, substantially as described above with reference to FIG. 2, via internet protocol communication channels 100 and 102, respectively, over an internet protocol network 104. In this instance, the signal gateway 96 and media gateway 98 are arranged to connect the internet protocol system 92 to a pulse code modulation network 106, for example a legacy public switched telephone network, via a pulse code modulation time division multiplexed link 108 between the media gateway 98 and the pulse code modulation network 106.

In this embodiment, the signalling is carried by the pulse code modulation link 108 to the media gateway 98, which in turn grooms the signalling out of the pulse code modulation data and transmits the signalling to the signalling gateway 96 over connection 108 between the media gateway 98 and the signalling gateway 96. In this manner, a separate signalling gateway 96 is maintained and receives signalling information via the media gateway 98.

Furthermore, signalling from the signalling gateway 96 can also be taken by the media gateway 98 and passed to the pulse code modulation network 106. The media gateway 98 places the signalling from the signalling gateway 96 into an appropriate timeslot of the appropriate pulse code modulation link 108 connected thereto.

1-15. (canceled)

16. A telecommunication network comprising:
a packet network;
a call control agent associated with the packet network, the call control agent being configured to control at least one communication channel across the packet network;
a media gateway associated with the call control agent, the media gateway being configured to receive and convert signals compatible with a first communication format into signals compatible with a second communication format; and
a media streaming unit associated with the media gateway, the media streaming unit configured to:
determine whether the signals compatible with the first communication format comprise media data;
if there is more than one communications channel connected to the media gateway, detect whether the media data is to be re-transmitted over another communications channel, or whether the media data is to be re-transmitted on another timeslot over the same communications channel; and
transfer the media data to a selected time slot on a selected one of the communications channels

17. The telecommunication network of claim 16 wherein the media streaming unit is configured to convert the media data into the signals compatible with the second communication format if the signals compatible with the first communication format comprise media data.

18. The telecommunication network of claim 16 further comprising a gateway core processor associated with the media gateway, and wherein the media streaming unit is configured to forward the signals compatible with the first communication format to the gateway core processor if the signals compatible with the first communication format do not comprise media data.

19. The telecommunication network of claim 16 wherein the media streaming unit determines whether the signals compatible with the first communication format comprise media data based on call detail records associated with the signals.

20. The telecommunication network of claim 16 wherein the media streaming unit is further configured to receive and convert signals compatible with the second communication format into the signals compatible with the first communication format.

21. The telecommunication network of claim of claim 20 wherein the media streaming unit is further configured to:
determine whether the signals compatible with the second communication format comprise media data; and
if the signals compatible with the second communication format comprise media data, convert the media data into the signals compatible with the first communication format.

22. The telecommunication network of claim 21 further comprising a gateway core processor associated with the media gateway, and wherein the media streaming unit is configured to forward the signals compatible with the second communication format to the gateway core processor if the signals compatible with the second communication format do not comprise media data.

23. The telecommunication network of claim 21 wherein the media streaming unit determines whether the signals compatible with the second communication format comprise media data based on call detail records associated with the signals.

24. The telecommunication network of claim 16 wherein the first communication format comprises pulse code modulation.

25. The telecommunication network of claim 24 wherein the second communication format comprises a packet data format.

26. The telecommunication network of claim 16 wherein the media streaming unit comprises a field programmable gate array.

27. A method of streaming data through a media gateway connected to one or more communications channels, the method comprising:
receiving signals compatible with a first communication format at a media gateway over a communications channel;
determining whether the signals compatible with the first communication format comprise media data;
if there is more than one communications channel connected to the media gateway, detecting whether the media data is to be re-transmitted over a different communications channel, or whether the media data is to be re-transmitted on a timesiot over the same communications channel; and
transferring the media data to a selected time slot on a selected one of the communications channels.

28. A media gateway interconnecting a first network to a second network via one or more communications channels, and configured to convert media data received in a first communication format to a second communication format, the media gateway comprising:
a media streaming unit configured to:
determine whether received signals compatible with a first communication format comprise media data;
detect whether the media data is to be re-transmitted over another communications channel, or whether the media data is to be re-transmitted on a timeslot over the same communications channel; and
transfer the media data to a selected time slot on a selected one of the communications channels.

29. The media gateway of claim 28 wherein if the signals compatible with the first communication format comprise media data, the media streaming unit is configured to convert the media data into the signals compatible with a second communication format for transmission over the selected one of the communications channels.

30. The media gateway of claim 28 further comprising a gateway core processor, and wherein the media streaming unit is configured to send the signals compatible with the first communication format to the gateway core processor if the signals compatible with the first communication format do not comprise media data.

31. The media gateway of claim 28 wherein the media streaming unit is configured to:
determine whether the signals compatible with the second communication format comprise media data; and
convert the media data into signals compatible with the first communication format if the signals compatible with the second communication format comprise media data.

32. The media gateway of claim 31 further comprising a gateway core processor, and wherein the media streaming unit is configured to send the signals compatible with the second communication format to the gateway core processor if the signals compatible with the second communication format do not comprise media data.
